(19) United States
(12) Patent Application Publication
(10) Pub. No.: US 2026/0302534 A1
(43) Pub. Date: Oct. 1, 2026

(54) BATTERY CELL, METHOD FOR COATING BATTERY CELL, AND METHOD FOR ASSEMBLING BATTERY CELL

(71) Applicant: HONDA MOTOR CO., LTD., Tokyo (JP)

(72) Inventors: Shigeyuki Kobayashi, Wako-shi (JP); Kyoka Itasaka, Wako-shi (JP); Tatsuya Hashimoto, Wako-shi (JP)

(21) Appl. No.: 19/550,398

(22) Filed: Feb. 26, 2026

(30) Foreign Application Priority Data
Mar. 26, 2025 (JP) 2025-051325

(51) Int. Cl. H01M 50/474; H01M 10/04; H01M 10/0585; H01M 50/105; H01M 50/477; H01M 50/486

(52) U.S. Cl. CPC H01M 50/474; H01M 10/049; H01M 10/0585; H01M 50/105; H01M 50/477; H01M 50/486

(57) ABSTRACT

A battery cell has an electrode assembly in which at least a positive electrode layer, an electrolyte layer, and a negative electrode layer are alternatively laminated in this order, the electrode assembly being laminated predetermined number which is three or more. The laminated electrode assemblies include resin layers on end portions on both sides that are positioned in a direction orthogonal to a lamination direction. The resin layer has a scalene triangle-like first inclined portion and a scalene triangle-like second inclined portion.

### CROSS-REFERENCE TO RELATED APPLICATION

Priority is claimed on Japanese Patent Application No. 2025-051325, filed Mar. 26, 2025, the content of which is incorporated herein by reference.

### BACKGROUND OF THE INVENTION

### Field of the Invention

The present invention relates to a battery cell, a method for coating a battery cell, and a method for assembling a battery cell.

### Description of Related Art

Research and development of batteries that contribute to energy efficiencies is underway to enable a lot more people to secure access to affordable, reliable, sustainable, and advanced energy.

For example, as batteries, a battery cell in which laminated electrode assemblies are inserted into a laminated cup and the inserted electrode assemblies are sealed in the laminated cup is known. In the battery cell, for example, an insulating layer is formed on the end portion of the laminated electrode assemblies, and the insulating properties of the end portion are guaranteed with a resin layer from the viewpoint of curbing a short circuit in the laminated electrode assemblies (for example, refer to Japanese Unexamined Patent Application, First Publication No. 2024-143433).

### SUMMARY OF THE INVENTION

Incidentally, in the technology of battery cells, it is conceivable that the insulating layer comes into contact with the laminated cup or is poorly inserted into the laminated cup at the time of inserting the laminated electrode assemblies into the laminated cup. Therefore, there is a concern that galling may occur in the insulating layer due to friction or the like against the laminated cup, and for example, the electrode assembly may deform (bend or the like).

An aspect of the present invention guarantees insulating properties and is capable of improving the inserting properties by laminated electrode assemblies. The aspect of the present invention contributes to improvement in energy efficiencies.

The aspect of the present invention adopted the following configurations.

1 A battery cell according to the present invention is a battery cell (for example, a battery cell 1 of an embodiment) having an electrode assembly (for example, electrode assemblies 20 of the embodiment) in which at least a positive electrode layers (positive electrode layers 21 of the embodiment), an electrolyte layer (for example, electrolyte layers 22 of the embodiment), and a negative electrode layer (negative electrode layers 23 of the embodiment) are alternatively laminated in this order, the electrode assembly being laminated predetermined number which is three or more, in which the laminated electrode assemblies include resin layers (for example, resin layers 10 of the embodiment) on end portions (for example, end portions 4c of the embodiment) on both sides that are positioned in a direction orthogonal to a lamination direction, and the resin layer has a scalene triangle-like inclined portion (for example, a first inclined portion 33 and a second inclined portion 35 of the embodiment).

In such a configuration, the resin layers are provided on the end portions on both sides of the laminated electrode assemblies, whereby it is possible to cover the end portions of the laminated electrode assemblies with the resin layers. This makes it possible to guarantee insulating properties in the end portions of the laminated electrode assemblies with the resin layers.

Here, when the laminated electrode assemblies are inserted into the laminated cup from an opening portion of the laminated cup, there is a concern that the resin layer of the laminated electrode assemblies may come into contact with a wall portion of the laminated cup to hinder the insertion of the battery cell into the laminated cup. Therefore, the resin layer is formed in a scalene triangle shape to form the inclined portion in the resin layer. Therefore, it is possible to insert the laminated electrode assemblies from an acute angle side of the resin layer with respect to the opening portion of the laminated cup. This makes it possible to improve the inserting properties into the laminated cup by the laminated electrode assemblies.

Improvement in the inserting properties of the laminated electrode assemblies makes it possible to curb the occurrence of galling in the resin layer with respect to the laminated cup at the time of inserting the laminated electrode assemblies into the laminated cup. This makes it possible to prevent, for example, the occurrence of deformation, such as bending, in the electrode assembly.

2 In the above-described aspect, in the resin layer, on the end portion of the laminated electrode assemblies, in a case where an angle formed between an outermost electrode assembly (for example, an outermost electrode assembly 20A or 20B of the embodiment) with which the resin layer is in contact and a tangent line (for example, a first tangent line L2 or a second tangent line L4 of the embodiment) that comes into contact with the inclined portion is indicated by θ (for example, a first inclination angle θ1 or a second inclination angle θ2 of the embodiment), the angle θ may be an acute angle of 40° or more and 80° or less, and the resin layer may be in a state of being inserted from the acute angle side of the scalene triangle into a laminated cup (for example, a laminated cup 12 of the embodiment).

In such a configuration, the angle θ of the inclined portion of the scalene triangle in the resin layer was set to an acute angle of 40° or more and 80° or less. Therefore, the resin layer is inserted into the laminated cup from the acute angle side of the scalene triangle in the resin layer, whereby it is possible to smoothly insert the resin layer into the laminated cup. This makes it possible to improve the inserting properties into the laminated cup by the laminated electrode assemblies.

3 In the above-described aspect, a resin that forms the resin layer may be a photocurable resin.

In such a configuration, a photocurable resin is used as the resin that forms the resin layer, whereby it is possible to cure the resin layer by irradiating the resin applied to the end portion of the laminated electrode assemblies with light. This makes it possible to appropriately form the inclined portion of the resin layer on the end portion of the laminated electrode assemblies.

4 In the above-described aspect, the photocurable resin may be a UV-curable resin.

In such a configuration, a UV (ultraviolet)-curable resin is used in the resin layer, whereby it is possible to cure the resin layer by irradiating the resin applied to the end portion of the laminated electrode assemblies with ultraviolet rays. In this case, the resin layer can be shrunk within a short period of time, and it is possible to curb the shrinkage of the resin layer after curing. This makes it possible to appropriately form the inclined portion of the resin layer on the end portion of the laminated electrode assemblies.

5 In the above-described aspect, the resin that forms the resin layer may be a thermosetting resin.

In such a configuration, a thermosetting resin is used as the resin that forms the resin layer, whereby it is possible to cure the resin layer by applying heat to the resin applied to the end portion of the laminated electrode assemblies. This makes it possible to appropriately form the inclined portion of the resin layer on the end portion of the laminated electrode assemblies.

6 In the above-described aspect, in the resin layer, thicknesses at front ends formed by the end portion and the inclined portion (a first front end 32 and a second front end 34) may be 0.2 mm or more and 1 mm or less, and the laminated electrode assemblies may be in a state of being inserted from an acute angle side in the inclined portion with respect to an opening portion (for example, an opening portion 17 of the embodiment) of the laminated cup.

In such a configuration, the thicknesses of the resin layer were set to 0.2 mm or more and 1 mm or less at the front ends on the acute angle sides. This makes it possible to secure the thickness of the resin layer. Furthermore, the laminated electrode assemblies were configured to be inserted from the acute angle side of the resin layer with respect to the opening portion of the laminated cup. As a result, it is possible to prevent, for example, damage to the resin layer at the time of inserting the laminated electrode assemblies from the opening portion. This makes it possible to improve the stiffness of the resin layer.

7 In the above-described aspect, a vertex (for example, a top portion 36 of the embodiment) of the scalene triangle of the resin layer may be in a state of being disposed inside a wall portion (for example, a wall portion 16 of the embodiment) of the laminated cup.

In such a configuration, the vertex of the scalene triangle of the resin layer was disposed inside the wall portion of the laminated cup. As a result, it is possible to insert the laminated electrode assemblies into the laminated cup in a state where the resin layer is not in contact with the wall portion of the laminated cup. This makes it possible to prevent the occurrence of galling in the resin layer due to friction against the laminated cup. Therefore, it is possible to prevent, for example, damage to the resin layer due to galling at the time of inserting the laminated electrode assemblies from the opening portion.

A method for coating a battery cell according to the present invention is a method for coating a battery cell having an electrode assembly in which at least a positive electrode layer, an electrolyte layer, and a negative electrode layer are alternatively laminated in this order, the electrode assembly being laminated predetermined number which is three or more, in which the electrode assemblies are laminated together, a resin (for example, a resin 50 of an embodiment) is applied to positions offset with respect to a center in a lamination direction on end portions of the laminated electrode assemblies to provide resin layers on the end portions on both sides that are positioned in a direction orthogonal to the lamination direction of the electrode assemblies, the resin layers are formed on the end portions to be capable of insulating, and inclined portions are formed in the resin layers.

In such a configuration, the electrode assemblies are laminated together, and the resin is applied to the positions offset with respect to the center in the lamination direction on the end portions on both sides of the laminated electrode assemblies. The application of the resin forms the resin layers on the end portions of the laminated electrode assemblies to be capable of insulating and forms the inclined portions in the resin layers. Therefore, it is possible to cover the end portions of the laminated electrode assemblies with the resin layers. This makes it possible to guarantee insulating properties in the end portions of the laminated electrode assemblies with the resin layers.

Here, when the laminated electrode assemblies are inserted into the laminated cup from the opening portion of the laminated cup, there is a concern that the resin layer of the laminated electrode assemblies may come into contact with the side wall of the laminated cup to hinder the insertion of the laminated electrode assemblies into the laminated cup. Therefore, the inclined portions were configured to be formed in the resin layers by applying the resin to the positions offset with respect to the center in the lamination direction on the end portions on both sides of the laminated electrode assemblies.

Therefore, it is possible to insert the laminated electrode assemblies from the acute angle side in the inclined portion of the resin layer with respect to the opening portion of the laminated cup. This makes it possible to improve the inserting properties into the laminated cup by the laminated electrode assemblies. Therefore, it is possible to curb the occurrence of galling in the resin layer with respect to the laminated cup at the time of inserting the laminated electrode assemblies into the laminated cup. This makes it possible to prevent, for example, the occurrence of deformation, such as bending, in the electrode assembly.

9 In the above-described aspect, the resin layer may be formed of one of a photocurable resin that is cured by irradiation with light or a thermosetting resin that is cured by applying heat thereto when an angle θ of the inclined portion has reached a desired angle of 40° or more and 80° or less.

In such a configuration, the resin layer is formed of a photocurable resin or a thermosetting resin, whereby the resin layer can be cured by irradiation with light or the application of light when the angle θ of the inclined portion has reached a desired angle of 40° or more and 80° or less. This makes it possible to form the angle θ of the inclined portion in the resin layer at a desired angle of 40° or more and 80° or less.

10 In the above-described aspect, on the end portions of the laminated electrode assemblies, the resin may be applied with the same offset from one end toward the other end in the lamination direction.

In such a configuration, the resin was configured to be applied with the same offset from one end toward the other end in a direction orthogonal to the lamination direction on each of the end portions of the laminated electrode assemblies. This makes it possible to form the resin layers having an angle θ of the inclined portion of 40° or more and 80° or less on the entire regions of the end portions.

11 In the above-described aspect, the photocurable resin may be a UV-curable resin.

In such a configuration, a UV (ultraviolet)-curable resin is used in the resin layer, whereby it is possible to cure the resin layer by irradiating the resin applied to the end portion of the laminated electrode assemblies with ultraviolet rays. In this case, the resin layer can be shrunk within a short period of time, and it is possible to curb the shrinkage of the resin layer after curing. This makes it possible to appropriately form the inclined portion of the resin layer on the end portion of the laminated electrode assemblies.

12 A method for assembling a battery cell according to the present invention is a method for assembling a battery cell that seals the laminated electrode assemblies according to (1) in a laminated cup, in which thicknesses of the resin layer at front ends formed by the end portion and the inclined portion are 0.2 mm or more and 1 mm or less, and the laminated electrode assemblies are inserted from an acute angle side with respect to an opening portion of the laminated cup.

In such a configuration, the thicknesses of the resin layer were set to 0.2 mm or more and 1 mm or less at the front ends on the acute angle sides. This makes it possible to secure the thickness of the resin layer. In this state, the laminated electrode assemblies were configured to be inserted from the acute angle side of the resin layer with respect to the opening portion of the laminated cup. As a result, it is possible to prevent, for example, damage to the resin layer at the time of inserting the laminated electrode assemblies from the opening portion. This makes it possible to improve the stiffness of the resin layer and to guarantee the insulating properties with the resin layers 10. Furthermore, the laminated electrode assemblies are inserted from the acute angle side of the resin layer with respect to the opening portion, whereby it is possible to smoothly insert the laminated electrode assemblies into the opening portion and to improve the inserting properties.

13 The method for assembling a battery cell according to the present invention is the method for assembling a battery cell that seals the laminated electrode assemblies according to (1) in a laminated cup, in which the resin layer is inserted in a state of being not in contact with the opening portion of the laminated cup, whereby the laminated electrode assemblies are sealed in the laminated cup.

In such a configuration, the resin layer was configured to be inserted in a state of being not in contact with the opening portion of the laminated cup. Therefore, it is possible to prevent the occurrence of galling in the resin layer due to friction against the laminated cup. This makes it possible to prevent, for example, damage to the resin layer due to galling at the time of inserting the laminated electrode assemblies from the opening portion.

According to the aspect of the present invention, it is possible to guarantee the insulating properties and to improve the inserting properties by the laminated electrode assemblies.

### BRIEF DESCRIPTION OF THE DRAWINGS

FIG. 1 is a perspective view illustrating a battery cell in a first embodiment of the present invention.

FIG. 2 is a cross-sectional view of the battery cell in FIG. 1 cut along a line II-II.

FIG. 3 is an enlarged cross-sectional view of an electrode assembly unit and a resin layer illustrated in FIG. 2.

FIG. 4 is a schematic view for describing an example in which a resin is applied to an end portion of the electrode assembly unit in the first embodiment.

FIG. 5 is a schematic view for describing an example in which the electrode assembly unit in the first embodiment is accommodated in a laminated cup.

### DETAILED DESCRIPTION OF THE INVENTION

Hereinafter, a battery cell, a method for coating a battery cell, and a method for assembling a battery cell according to one embodiment of the present invention will be described with reference to drawings.

### First Embodiment

### Battery Cell

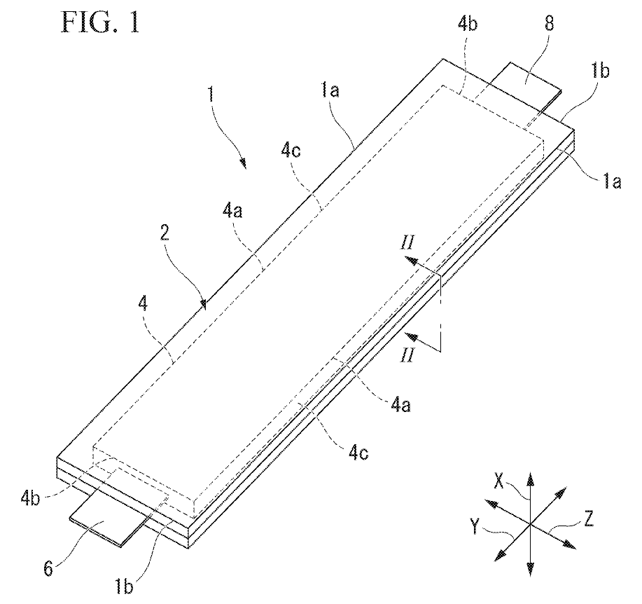

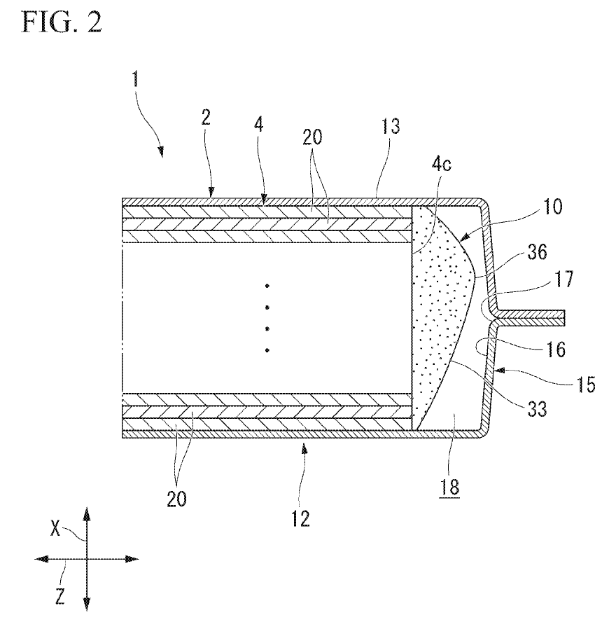

FIG. 1 is a perspective view illustrating a battery cell. FIG. 2 is a cross-sectional view of the battery cell in FIG. 1 cut along a line II-II.

As illustrated in FIG. 1 and FIG. 2, a battery cell 1 is configured to be attachable to and detachable from, for example, a variety of power devices. Power devices that the battery cell 1 is attached to and detached from are, for example, electrically operated vehicles, electrically operated mobile objects, electrically operated machines, power supply units, a variety of electrical apparatuses, and the like.

The electrically operated vehicles are, for example, electrical vehicles, saddle-riding type vehicles, and kick scooters each including a rotary electrical machine that is driven by the power of the battery cell 1 as a power source, hybrid vehicles in which a rotary electrical machine and an internal combustion engine are combined together, fuel cell vehicles in which the battery cell 1 and a fuel cell are combined together, and the like. The electrically operated mobile objects are, for example, robots, flying objects, water-surface and underwater moving objects, and the like. The electrically operated machines are, for example, construction machines including a rotary electrical machine as a power source and the like. The power supply units are, for example, stationary or mobile power supply units in which the battery cell 1 is charged and discharged and the like.

The battery cell 1 is formed in, for example, a substantially rectangular shape and has a pair of long sides 1a and a pair of short sides 1b. The battery cell 1 includes, for example, an exterior body 2, an electrode assembly unit 4, a positive electrode tab lead 6, a negative electrode tab lead 8, and resin layers 10.

The exterior body 2 includes a first laminated cup 12 and a second laminated cup 13. The exterior body 2 seals the electrode assembly unit 4 with the first laminated cup 12 and the second laminated cup 13 in a state of accommodating the electrode assembly unit 4 therein. The first laminated cup 12 and the second laminated cup 13 are formed in approximately the same manner. Hereinafter, an example in which the first laminated cup 12 is used as a laminated cup 12 and the electrode assembly unit 4 is accommodated in the laminated cup 12 will be described.

The laminated cup 12 has a recessed portion 15 capable of accommodating the electrode assembly unit 4, a wall portion 16 of the recessed portion 15, and an opening portion 17 that opens the recessed portion 15. The recessed portion 15 has a space 18 in which the electrode assembly unit 4 is accommodated from the opening portion 17.

The electrode assembly unit 4 is formed in, for example, a substantially rectangular shape. In the electrode assembly unit 4, a plurality of electrode assemblies 20 are laminated together. The electrode assembly unit 4 is sealed in the exterior body 2 in a state of being accommodated in the recessed portion 15 of the laminated cup 12. The electrode assembly unit 4 will be described in detail below.

The positive electrode tab lead 6 is a lead for positive electrodes connected to positive electrodes of the plurality of electrode assemblies 20 through current collector tabs (not illustrated). The negative electrode tab lead 8 is a lead for negative electrodes connected to negative electrodes of the plurality of electrode assemblies 20 through current collector tabs (not illustrated).

### Electrode Assembly Unit

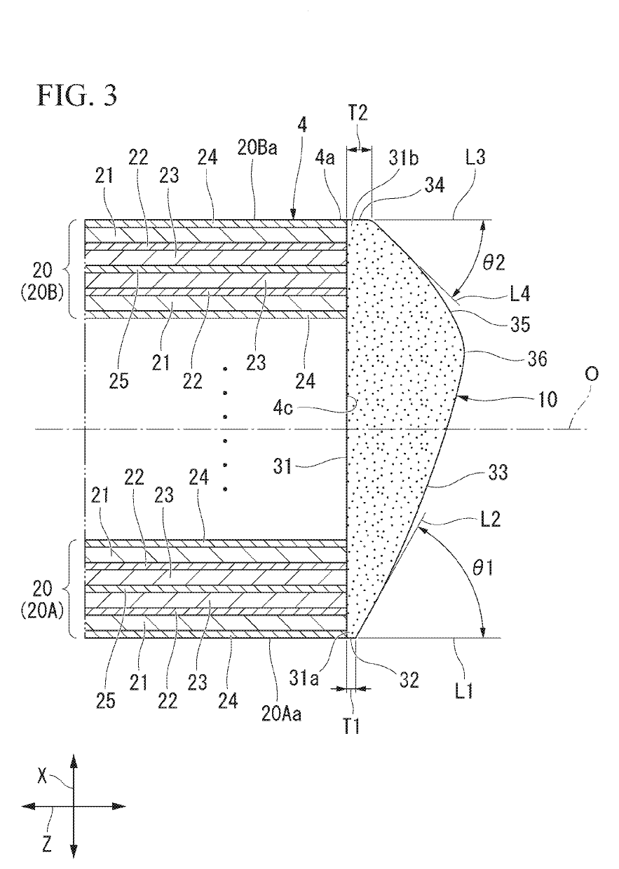

FIG. 3 is an enlarged cross-sectional view of the electrode assembly unit and the resin layer illustrated in FIG. 2.

As illustrated in FIG. 2 and FIG. 3, the electrode assembly unit 4 has the electrode assemblies 20 laminated in a plurality of layers. In the electrode assemblies 20, for example, at least a positive electrode layer 21, an electrolyte layer 22, and a negative electrode layer 23 are alternatively laminated in this order and this electrode assembly is laminated predetermined number which is three or more.

Specifically, in the electrode assembly 20, the positive electrode layer 21, the electrolyte layer 22, and the negative electrode layer 23 are laminated in this order. In addition, the electrode assembly 20 has a positive electrode foil 24 on a side of the positive electrode layer 21 opposite to the electrolyte layer 22. Furthermore, the electrode assembly 20 has a negative electrode foil 25 on a side of the negative electrode layer 23 opposite to the electrolyte layer 22. That is, in the electrode assemblies 20, the negative electrode layer 23, the electrolyte layer 22, the positive electrode layer 21, and the positive electrode foil 24 are laminated in this order on both surfaces of the negative electrode foil 25.

In the electrode assembly unit 4, for example, the electrode assemblies 20 are laminated in a plurality of layers that can be selected from a range of 20 layers or more and 100 layers or less, approximately 50 layers. That is, the electrode assembly unit 4 is composed of the plurality of electrode assemblies 20 laminated together. The electrode assembly unit 4 includes an electrode assembly 20 that is positioned outermost on one side and an electrode assembly 20 that is positioned outermost on the other side in the lamination direction of the laminated electrode assemblies 20. Hereinafter, the electrode assembly 20 that is positioned outermost on one side and the electrode assembly 20 that is positioned outermost on the other side will be described as “electrode assembly 20A” and “electrode assembly 20B,” respectively, in some cases.

As illustrated in FIG. 1, the electrode assembly unit 4 is formed in, for example, a substantially rectangular shape. The electrode assembly unit 4 has a pair of the long sides 4a on both sides orthogonal to the lamination direction of the electrode assemblies 20. In addition, the electrode assembly unit 4 has a pair of the short sides 4b on both sides orthogonal to the pair of long sides 4a in a direction orthogonal to the lamination direction of the electrode assemblies 20.

Hereinafter, in some cases, the lamination direction of the electrode assemblies 20 will be described as the X direction, and a direction orthogonal to the lamination direction of the electrode assemblies 20 and along the pair of long sides 4a will be described as the Z direction. In addition, a direction orthogonal to the lamination direction of the electrode assemblies 20 and along the pair of short sides 4b will be described as the Y direction.

In the electrode assembly unit 4, the resin layers 10 (refer to FIG. 3) are provided on end portions 4c disposed in the lamination direction of the electrode assemblies 20 in the pair of long sides 4a.

### Resin Portion

As illustrated in FIG. 3, the resin layers 10 are provided in the entire regions in the X direction and the Y direction (refer to FIG. 1) of the end portions 4c (in FIG. 3, only one end portion 4c is illustrated) of the electrode assembly unit 4 on both sides. The end portions 4c on both sides are positioned on the pair of long sides 4a in the electrode assembly unit 4. Furthermore, the end portions 4c on both sides are formed in the X direction in which the plurality of electrode assemblies 20 are laminated together. Hereinafter, between the end portions 4c on both sides, the resin layer 10 provided on one end portion 4c illustrated in FIG. 3 will be described, and a resin layer provided on the other end portion 4c (refer to FIG. 1) will not be described. In addition, the one end portion 4c will be simply referred to as “end portion 4c” in some cases.

A cross section of the resin layer 10 is formed in a scalene triangle shape. Here, the scalene triangle includes shapes formed in substantially scalene triangle shapes, which will be described below. The scalene triangle shape is not limited to the shape of the first embodiment to be described below. Examples of a resin material that forms the resin layer 10 include photocurable resins, but UV-curable resins are more preferable.

The resin layer 10 has a bottom portion 31, a first front end (front end) 32, a first inclined portion (inclined portion) 33, a second front end (front end) 34, a second inclined portion (inclined portion) 35, and a top portion (vertex) 36. The resin layer 10 is formed in a scalene triangle shape (specifically, formed in a substantially scalene triangle shape) with the bottom portion 31, the first front end 32, the first inclined portion 33, the second front end 34, the second inclined portion 35, and the top portion 36.

The bottom portion 31 is in contact with the entire region in the X direction and the Y direction (refer to FIG. 1) of an end portion 4c of the electrode assembly unit 4. The first front end 32 is provided at one end 31a of the bottom portion 31. The one end 31a of the bottom portion 31 is positioned on an external surface 20Aa side of the electrode assembly 20A. The first front end 32 is provided along a first extension line L1 that extends in the Z direction orthogonal to the lamination direction of the electrode assemblies 20 from the external surface 20Aa. The first front end 32 is a portion at a front end formed at an acute angle by the bottom portion 31 and the first inclined portion 33 (which will be described below). The thickness T1 of the first front end 32 is 0.2 mm or more and 1 mm or less in the Z direction orthogonal to the lamination direction of the electrode assemblies 20.

The reason for the thickness T1 of the first front end 32 being 0.2 mm or more and 1 mm or less will be described in detail below.

The first inclined portion 33 is formed at an inclination angle that is formed by a first tangent line (tangent line) L2 with respect to the first extension line L1. The first tangent line L2 is a straight line that extends from the first front end 32 to come into contact with the first inclined portion 33. Hereinafter, the inclination angle that is formed by the first extension line L1 and the first tangent line L2 will be described as a first inclination angle θ1. The first inclination angle θ1 is an acute angle of 40° or more and 80° or less. Hereinafter, the first front end 32 side in the first inclined portion 33 will be referred to as “the acute angle side of the first inclined portion 33” in some cases. The reason for the first inclination angle θ1 being an acute angle of 40° or more and 80° or less will be described in detail below.

The second front end 34 is provided at the other end 31b of the bottom portion 31. The other end 31b of the bottom portion 31 is positioned on an external surface 20Ba side of the electrode assembly 20B. The second front end 34 is provided along a second extension line L3 that extends in the Z direction orthogonal to the lamination direction of the electrode assemblies 20 from the external surface 20Ba. The second front end 34 is a portion at a front end formed at an acute angle by the bottom portion 31 and the second inclined portion 35 (which will be described below). The thickness T2 of the second front end 34 is 0.2 mm or more and 1 mm or less in the Z direction orthogonal to the lamination direction of the electrode assemblies 20.

The reason for the thickness T2 of the second front end 34 being 0.2 mm or more and 1 mm or less is the same as the reason for the thickness T1 of the first front end 32 being 0.2 mm or more and 1 mm or less.

The second inclined portion 35 is formed at an inclination angle that is formed by a second tangent line (tangent line) L4 with respect to the second extension line L3. The second tangent line L4 is a straight line that extends from the second front end 34 to come into contact with the second inclined portion 35. Hereinafter, the inclination angle that is formed by the second extension line L3 and the second tangent line L4 will be described as a second inclination angle θ2. The second inclination angle θ2 is an acute angle of 40° or more and 80° or less. Hereinafter, the second front end 34 side in the second inclined portion 35 will be referred to as “the acute angle side of the second inclined portion 35” in some cases. The reason for the second inclination angle θ2 being an acute angle of 40° or more and 80° or less is the same as the reason for the first inclination angle θ1 being an acute angle of 40° or more and 80° or less.

The top portion 36 is a portion at which the first inclined portion 33 and the second inclined portion 35 intersect with each other. The top portion 36 is a portion that protrudes most in the Z direction orthogonal to the lamination direction of the electrode assemblies from the end portion 4c in the resin layer 10. The top portion 36 is formed at a position offset (displaced) toward the second front end 34 side (that is, the external surface 20Ba side of the electrode assembly 20B) with respect to a straight line O that passes through the center in the lamination direction of the electrode assemblies 20 and extends in the Z direction. Hereinafter, the straight line O will be described as “central line O” of the electrode assembly unit 4.

As illustrated in FIG. 1 and FIG. 2, in the battery cell 1, the positive electrode tab lead 6 and the negative electrode tab lead 8 are connected to the electrode assembly unit 4, and the resin layers 10 are provided on the end portions 4c of the electrode assembly unit 4. In this state, the electrode assembly unit 4 is inserted into the opening portion 17 of the laminated cup 12 from, for example, the acute angle side of the first inclined portion 33 and falls into a state of being stored in the space 18 of the recessed portion 15 in the laminated cup 12. In addition, the top portion 36 of the resin layer 10 is in a state of being disposed inside the wall portion 16 of the recessed portion 15 in the laminated cup 12 or a wall portion of a recessed portion in the second laminated cup 13 in the Z direction orthogonal to the lamination direction of the electrode assemblies 20.

### Method for Coating Battery Cell

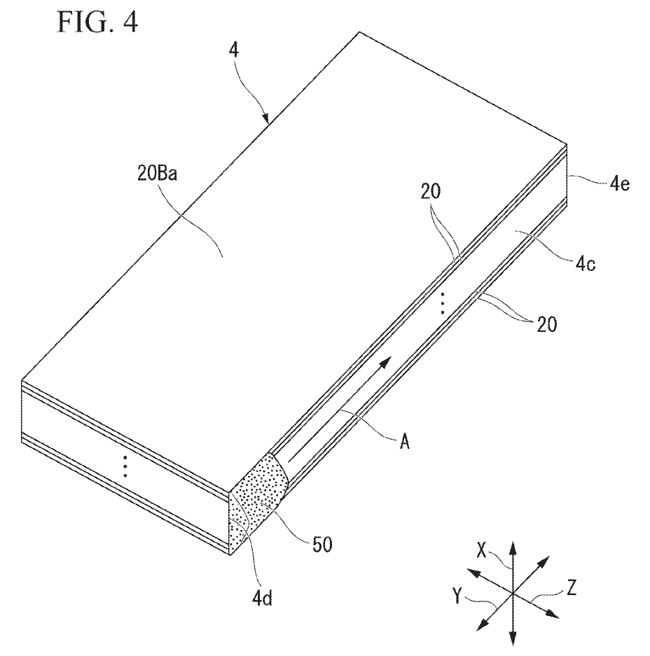

Next, a method for coating the battery cell 1 in which a resin 50 is applied to the end portions 4c of the electrode assembly unit 4 in the first embodiment to form the resin layers 10 will be described based on FIG. 3 and FIG. 4.

FIG. 4 is a schematic view for describing an example in which the resin is applied to the end portion of the electrode assembly unit.

As illustrated in FIG. 3 and FIG. 4, first, the plurality of electrode assemblies 20 are laminated together. The resin 50 is applied to an end portion 4c of the electrode assembly unit 4 in which the electrode assemblies 20 have been laminated together with an offset coating device (not illustrated). Specifically, the resin 50 is applied from one end 4d toward the other end 4e of the end portion 4c in the Y direction orthogonal to the lamination direction of the electrode assemblies 20 as illustrated by an arrow A. At this time, the resin 50 is applied to a position offset toward the external surface 20Ba side of the electrode assembly 20B with respect to the central line O of the electrode assembly unit 4. That is, the resin 50 is applied with the same offset from the one end 4d toward the other end 4e of the end portion 4c. As the resin 50, among photocurable resins, a UV-curable resin is used.

When the inclination angle θ1 of the first inclined portion 33 and the inclination angle θ2 of the second inclined portion 35 in the resin 50 applied to the end portion 4c reach desired slopes of 40° or more and 80° or less and 40° or more and 80° or less, respectively, the resin 50 is irradiated with light (ultraviolet rays) to be cured.

Here, the applied resin 50 is cured by confirming times taken for the inclination angle θ1 of the first inclined portion 33 and the inclination angle θ2 of the second inclined portion 35 to reach desired slopes of 40° or more and 80° or less and 40° or more and 80° or less, respectively, in advance and managing the confirmed times.

Alternatively, the applied resin 50 is cured at confirmed positions after positions at which the inclination angle θ1 of the first inclined portion 33 and the inclination angle θ2 of the second inclined portion 35 to reach desired slopes of 40° or more and 80° or less and 40° or more and 80° or less, respectively, are confirmed in advance in an application step.

The resin layers 10 can be provided on the end portions 4c by curing the resin 50 applied to the end portions 4c. Therefore, it is possible to guarantee the insulating properties at the end portions 4c of the electrode assembly unit (that is, the laminated electrode assemblies 20) with the resin layers 10. In addition, it is possible to form the first inclined portion 33 and the second inclined portion 35 in the resin layer 10.

As a result, the method for coating the battery cell 1 in which the resin 50 is applied to the end portions 4c of the electrode assembly unit 4 is completed.

### Method for Assembling Battery Cell

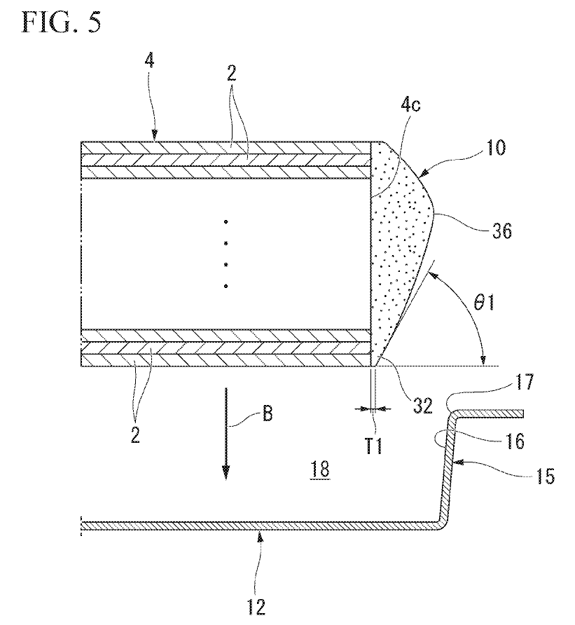

Next, a method for assembling the battery cell 1 in which the electrode assembly unit 4 in the first embodiment is accommodated in the laminated cup 12 will be described based on FIG. 5.

Hereinafter, as a representative example of the method for assembling the battery cell 1, an example in which the electrode assembly unit 4 is accommodated with the acute angle side of the first inclined portion 33 of the resin layer 10 facing the opening portion 17 of the laminated cup 12 will be described. In the method for assembling the battery cell 1, the electrode assembly unit 4 may be accommodated with the acute angle side of the second inclined portion 35 of the resin layer 10 facing the opening portion 17 of the laminated cup 12.

FIG. 5 is a schematic view for describing an example in which the electrode assembly unit is accommodated in the laminated cup.

As illustrated in FIG. 5, the positive electrode tab lead 6 and the negative electrode tab lead 8 (refer to FIG. 1 for both) are connected to the electrode assembly unit 4, and the resin layers 10 are provided on the end portions 4c of the electrode assembly unit 4. In this state, the electrode assembly unit 4 is inserted into the opening portion 17 of the laminated cup 12 from the acute angle side of the first inclined portion 33 as illustrated by an arrow B. At this time, it is preferable to insert the resin layer 10 in a state of being not in contact with the opening portion 17 of the laminated cup 12.

Here, the first inclination angle θ1 of the first inclined portion 33 was set to an acute angle of 40° or more and 80° or less. The reason for setting the first inclination angle θ1 to an acute angle of 40° or more and 80° or less is as described below.

That is, in a case where the first inclination angle θ1 is less than 40°, there is a concern that galling may occur in the resin layer 10 due to friction caused by the first inclined portion 33 coming into the opening portion 17 or the like. In addition, in a case where the first inclination angle θ1 exceeds 80°, the resin layer 10 is likely to peel off from the end portion 4c of the electrode assembly unit 4, and it is difficult to guarantee the insulating properties of the end portion 4c with the resin layer 10.

Therefore, the first inclination angle θ1 was set to an acute angle of 40° or more and 80° or less. When the first inclination angle θ1 is set to 40° or more, the occurrence of galling in the resin layer 10 is curbed, and it is possible to smoothly insert the resin layer 10 into the opening portion 17 or the recessed portion 15 of the laminated cup 12. This makes it possible to improve the inserting properties into the opening portion 17 or the recessed portion 15 by the electrode assembly unit 4. In addition, when the first inclination angle θ1 is set to 80° or less, it is possible to guarantee the insulating properties of the end portion 4c with the resin layer 10 by preventing the resin layer 10 from peeling off from the end portion 4c of the electrode assembly unit 4.

Furthermore, the thickness T1 of the first front end 32 was set to 0.2 mm or more and 1 mm or less. The reason for setting the thickness T1 of the first front end 32 to 0.2 mm or more and 1 mm or less is as described below.

That is, in a case where the thickness T1 of the first front end 32 is less than 0.2 mm, the resin layer 10 is likely to be damaged, and it is difficult to guarantee the insulating properties of the end portion 4c with the resin layer 10. In addition, in a case where the thickness T1 of the first front end 32 exceeds 1 mm, there is a concern that galling may occur in the resin layer 10 due to friction caused by the first inclined portion 33 coming into the opening portion 17 or the like.

Therefore, the thickness T1 of the first front end 32 was set to 0.2 mm or more and 1 mm or less. When the thickness T1 of the first front end 32 is set to 0.2 mm or more, it is possible to guarantee the insulating properties of the end portion 4c with the resin layer 10 by improving the stiffness of the resin layer 10. In addition, when the thickness T1 of the first front end 32 is set to 1 mm or less, the occurrence of galling in the resin layer 10 is curbed, and it is possible to improve the inserting properties of the resin layer 10 with respect to the opening portion 17 or the like of the laminated cup 12.

The electrode assembly unit 4 is inserted from the acute angle side of the first inclined portion 33 with respect to the opening portion 17 of the laminated cup 12 as described above, whereby the electrode assembly unit 4 is stored in the space 18 of the recessed portion 15 in the laminated cup 12 from the opening portion 17. At this time, the top portion 36 of the resin layer 10 is disposed inside the wall portion 16 of the recessed portion 15 in the laminated cup 12. In this state, the electrode assembly unit 4 is sealed with the laminated cup 12 and the second laminated cup 13 (refer to FIG. 2).

According to the battery cell 1 according to the first embodiment described above, as illustrated in FIG. 3, the resin layers 10 are provided on the end portions 4c on both sides in the laminated electrode assemblies 20 (that is, the electrode assembly unit 4). Therefore, it is possible to cover the end portions 4c of the laminated electrode assemblies 20 with the resin layers 10. This makes it possible to secure the insulating properties in the end portions 4c of the laminated electrode assemblies 20 with the resin layers.

Here, at the time of inserting the electrode assembly unit 4 into the recessed portion 15 from the opening portion 17 of the laminated cup 12 as illustrated in FIG. 5, there is a concern that the resin layer 10 may come into contact with the opening portion 17 or the wall portion 16 of the recessed portion 15 and the insertion of the electrode assembly unit 4 into the recessed portion 15 may be hindered. Therefore, the first inclined portion 33 or the second inclined portion 35 was formed on the resin layer 10 by forming the resin layer 10 in a scalene triangle shape. Therefore, it is possible to insert the electrode assembly unit 4 into the recessed portion 15 of the laminated cup 12 from the acute angle side of the first inclined portion 33 or the second inclined portion 35 of the resin layer 10. This makes it possible to improve the inserting properties into the recessed portion 15 by the electrode assembly unit 4.

Improvement in the inserting properties of the electrode assembly unit 4 makes it possible to curb the occurrence of galling in the resin layer 10 with respect to the wall portion 16 of the recessed portion 15 or the like at the time of inserting the electrode assembly unit into the recessed portion 15. This makes it possible to prevent, for example, the occurrence of deformation, such as bending, in the laminated electrode assemblies 20.

In addition, the angles θ of the first inclined portion 33 and the second inclined portion 35 in a scalene triangle shape in the resin layer 10 were set to an acute angle of 40° or more and 80° or less. Therefore, it is possible to smoothly insert the resin layer 10 into the recessed portion 15 by inserting the resin layer 10 from the acute angle side of the scalene triangle in the resin layer 10. This makes it possible to improve the inserting properties into the recessed portion 15 by the electrode assembly unit 4.

In addition, a photocurable resin is used as the resin 50 that forms the resin layer 10, whereby it is possible to cure the resin layer 10 by irradiating the resin 50 applied to the end portion 4c of the electrode assembly unit 4 with light as illustrated in FIG. 4. This makes it possible to appropriately form the first inclined portion 33 and the second inclined portion 35 in the resin layer 10 on the end portion 4c of the electrode assembly unit 4.

Furthermore, a UV (ultraviolet ray)-curable resin is used as the resin 50, whereby it is possible to cure the resin layer 10 by irradiating the resin 50 applied to the end portion 4c of the electrode assembly unit 4 with ultraviolet rays as illustrated in FIG. 3 and FIG. 4. In this case, the resin 50 can be shrunk within a short period of time, and it is possible to curb the shrinkage of the resin 50 after curing. This makes it possible to appropriately form the first inclined portion 33 and the second inclined portion 35 of the resin layer 10 on the end portion 4c of the electrode assembly unit 4.

In addition, as illustrated in FIG. 3, the thickness T1 of the first front end and the thickness T2 of the second front end in the resin layer 10 were set to 0.2 mm or more and 1 mm or less. This makes it possible to secure the thickness of the resin layer 10. Furthermore, the electrode assembly unit 4 was configured to be inserted from the acute angle side of the first inclined portion 33 or the acute angle side of the second inclined portion 35 with respect to the opening portion 17 or the recessed portion 15. Therefore, it is possible to prevent, for example, the resin layer 10 from being damaged at the time of inserting the electrode assembly unit 4 into the recessed portion 15 from the opening portion 17. This makes it possible to improve the stiffness of the resin layer.

Furthermore, as illustrated in FIG. 2 and FIG. 5, the top portion 36 of the scalene triangle of the resin layer 10 was disposed inside the wall portion 16 of the recessed portion 15. Therefore, it is possible to insert the electrode assembly unit 4 into the recessed portion 15 in a state in which the resin layer 10 is not in contact with the wall portion 16 of the recessed portion 15. This makes it possible to prevent the occurrence of galling in the resin layer 10 due to friction against the wall portion 16 of the recessed portion 15. Therefore, it is possible to prevent, for example, the resin layer 10 from being damaged due to galling at the time of inserting the electrode assembly unit 4 from the opening portion 17.

According to the method for coating the battery cell 1 according to the first embodiment described above, as illustrated in FIG. 3 and FIG. 4, first, the electrode assembly unit 4 is configured by laminating the electrode assemblies 20. Next, the resin 50 is applied to positions offset with respect to the central line O on the end portions 4c on both sides in the electrode assembly unit 4. The application of the resin 50 forms the resin layer 10 on the end portions 4c to be capable of insulating and forms the first inclined portions 33 and the second inclined portions 35 in the resin layers 10. Therefore, it is possible to cover the end portions 4c of the electrode assembly unit 4 with the resin layers 10. This makes it possible to guarantee insulating properties in the end portions 4c of the electrode assembly unit 4 with the resin layers 10.

Here, at the time of inserting the electrode assembly unit 4 into the recessed portion 15 from the opening portion 17 of the laminated cup 12 as illustrated in FIG. 3 and FIG. 5, there is a concern that the resin layer 10 of the electrode assembly unit 4 may come into contact with the wall portion 16 of the recessed portion 15 and the insertion of the electrode assembly unit 4 into the recessed portion 15 may be hindered. Therefore, the first inclined portions 33 and the second inclined portions 35 were configured to be formed on the resin layers 10 by applying the resin 50 to the position offset with respect to the central line O on the end portions 4c on both sides in the electrode assembly unit 4.

Therefore, it is possible to insert the electrode assembly unit 4 into the recessed portion 15 of the laminated cup 12 from the acute angle side of the first inclined portion 33 or the second inclined portion 35. This makes it possible to improve the inserting properties into the recessed portion 15 by the electrode assembly unit 4. Therefore, it is possible to curb the occurrence of galling in the resin layer 10 with respect to the recessed portion 15 at the time of inserting the electrode assembly unit 4 into the recessed portion 15. This makes it possible to prevent, for example, the occurrence of deformation, such as bending, in the laminated electrode assemblies 20.

In addition, when the resin layer 10 is formed of a photocurable resin, the resin layer 10 can be cured by irradiation with light when the first inclination angle θ1 of the first inclined portion 33 and the second inclination angle θ2 of the second inclined portion 35 reach desired slopes of 40° or more and 80° or less as illustrated in FIG. 3 and FIG. 4. This makes it possible to form the first inclination angle θ1 of the first inclined portion 33 and the second inclination angle θ2 of the second inclined portion 35 in the resin layer 10 at desired slopes of 40° or more and 80° or less.

Furthermore, on the end portions 4c of the electrode assembly unit 4, the resin 50 was configured to be applied with the same offset in the Y direction orthogonal to the lamination direction of the electrode assemblies 20. This makes it possible to form the resin layers 10 having a first inclination angle θ1 of the first inclined portion 33 and a second inclination angle θ2 of the second inclined portion 35 of 40° or more and 80° or less on the entire regions of the end portions 4c.

Additionally, a UV (ultraviolet ray)-curable resin is used in the resin layers 10, whereby it is possible to cure the resin layers 10 by irradiating the resin 50 applied to the end portions 4c of the electrode assembly unit 4 with ultraviolet rays. Therefore, the resin layers 10 can be shrunk within a short period of time, and it is possible to curb the shrinkage after curing. This makes it possible to appropriately form the first inclined portions 33 and the second inclined portions 35 of the resin layers 10 on the end portions 4c of the electrode assembly unit 4.

According to the method for assembling the battery cell 1 according to the first embodiment described above, as illustrated in FIG. 3 and FIG. 5, the first front end 32 was formed in a thickness T1 of 0.2 mm or more and 1 mm or less. In addition, the second front end 34 was formed in a thickness T2 of 0.2 mm or more and 1 mm or less. This makes it possible to secure the thickness of the resin layer 10.

The electrode assembly unit 4 was configured to be inserted from the acute angle side of the first inclined portion 33 or the acute angle side of the second inclined portion 35 with respect to the opening portion 17 or the recessed portion 15. Therefore, it is possible to prevent, for example, the resin layer 10 from being damaged at the time of inserting the electrode assembly unit 4 from the opening portion 17. This makes it possible to improve the stiffness of the resin layer 10 and to guarantee the insulating properties with the resin layer 10.

Furthermore, the electrode assembly unit 4 is inserted from the acute angle side of the first inclined portion 33 or the second inclined portion 35 with respect to the opening portion 17, whereby it is possible to smoothly insert the electrode assembly unit 4 into the opening portion 17 and to improve the inserting properties.

In addition, as illustrated in FIG. 5, the resin layer 10 was configured to be inserted in a state of being not in contact with the opening portion 17 of the recessed portion 15. Therefore, it is possible to prevent the occurrence of galling in the resin layer 10 due to friction against the opening portion 17. This makes it possible to prevent, for example, the resin layer 10 from being damaged due to galling at the time of inserting the electrode assembly unit 4 from the opening portion 17.

### Second Embodiment

Next, a second embodiment will be described based on FIG. 3 to FIG. 5 with the same sign for each component of the first embodiment.

As illustrated in FIG. 3 and FIG. 4, in the battery cell 1 of the second embodiment, a thermosetting resin is used as the resin material of the resin layer 10 instead of the photocurable resin of the first embodiment. According to the battery cell 1 of the second embodiment, a thermosetting resin is used as the resin material of the resin layer 10, whereby the resin layer 10 can be cured by applying heat to the resin 50 applied to the end portion 4c of the electrode assembly unit 4. This makes it possible to appropriately form the first inclined portion 33 and the second inclined portion 35 in the resin layer 10 on the end portion 4c of the electrode assembly unit 4.

In addition, according to a method for coating the battery cell 1 of the second embodiment, the resin layer 10 is formed of the thermosetting resin, whereby the resin layer 10 can be cured by heating with heat when the first inclination angle θ1 of the first inclined portion 33 and the second inclination angle θ2 of the second inclined portion 35 reach desired slopes of 40° or more and 80° or less. Therefore, it is possible to form the first inclination angle θ1 of the first inclined portion 33 and the second inclination angle θ2 of the second inclined portion 35 in the resin layer 10 at desired slopes of 40° or more and 80° or less.

Furthermore, as illustrated in FIG. 5, according to a method for assembling the battery cell 1 of the second embodiment, it is possible to smoothly insert the resin layer 10 into the opening portion 17 or the recessed portion 15 of the laminated cup 12 as in the first embodiment. In addition, it is possible to prevent the resin layer 10 from peeling off from the end portion 4c of the electrode assembly unit 4.

According to the battery cell 1, the method for coating the battery cell 1, and the method for assembling the battery cell 1 according to the second embodiment described above, it is possible to guarantee the insulating properties in the end portions 4c of the electrode assembly unit 4 with the resin layer 10 as in the first embodiment. Furthermore, it is possible to improve the inserting properties into the laminated cup 12 by the electrode assembly unit 4.

The technical scope of the present invention is not limited to the above-described embodiments, and a variety of modifications can be added within the scope not departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A battery cell comprising:
an electrode assembly in which at least a positive electrode layer, a electrolyte layer, and a negative electrode layer are alternatively laminated in this order, the electrode assembly being laminated predetermined number which is three or more,
wherein the laminated electrode assemblies include resin layers on end portions on both sides that are positioned in a direction orthogonal to a lamination direction, and
the resin layer has a scalene triangle-like inclined portion.

2. The battery cell according to claim 1, wherein in the resin layer, on the end portion of the laminated electrode assemblies, in a case where an angle formed between an outermost electrode assembly with which the resin layer is in contact and a tangent line that comes into contact with the inclined portion is indicated by θ, the angle θ is an acute angle of 40° or more and 80° or less, and
the resin layer is in a state of being inserted from the acute angle side of the scalene triangle into a laminated cup.

3. The battery cell according to claim 1, wherein a resin that forms the resin layer is a photocurable resin.

4. The battery cell according to claim 3, wherein the photocurable resin is a UV-curable resin.

5. The battery cell according to claim 1, wherein the resin that forms the resin layer is a thermosetting resin.

6. The battery cell according to claim 2, wherein in the resin layer, a thickness at a front end formed by the end portion and the inclined portion is 0.2 mm or more and 1 mm or less, and
the laminated electrode assemblies are in a state of being inserted from an acute angle side in the inclined portion with respect to an opening portion of the laminated cup.

7. The battery cell according to claim 6, wherein a vertex of the scalene triangle of the resin layer is in a state of being disposed inside a wall portion of the laminated cup.

8. A method for coating a battery cell having an electrode assembly in which at least a positive electrode layer, a electrolyte layer, and a negative electrode layer are alternatively laminated in this order, the electrode assembly being laminated predetermined number which is three or more,
wherein the electrode assemblies are laminated together,
a resin is applied to positions offset with respect to a center in a lamination direction on end portions of the laminated electrode assemblies to provide resin layers on the end portions on both sides that are positioned in a direction orthogonal to the lamination direction of the electrode assemblies,
the resin layers are formed on the end portions to be capable of insulating, and inclined portions are formed in the resin layers.

9. The method for coating a battery cell according to claim 8, wherein the resin layer is formed of one of a photocurable resin that is cured by irradiation with light or a thermosetting resin that is cured by applying heat thereto when an angle θ of the inclined portion has reached a desired angle of 40° or more and 80° or less.

10. The method for coating a battery cell according to claim 8, wherein on the end portions of the laminated electrode assemblies, the resin is applied with the same offset from one end toward the other end in the lamination direction.

11. The method for coating a battery cell according to claim 9, wherein the photocurable resin is a UV-curable resin.

12. A method for assembling a battery cell that seals the laminated electrode assemblies according to claim 1 in a laminated cup,
wherein a thickness of the resin layer at a front end formed by the end portion and the inclined portion is 0.2 mm or more and 1 mm or less, and
the laminated electrode assemblies are inserted from an acute angle side with respect to an opening portion of the laminated cup.

13. A method for assembling a battery cell that seals the laminated electrode assemblies according to claim 1 in a laminated cup,
wherein the resin layer is inserted in a state of being not in contact with the opening portion of the laminated cup, whereby the laminated electrode assemblies are sealed in the laminated cup.
